(19) United States
(12) Patent Application Publication
(10) Pub. No.: US 2005/0230310 A1
(43) Pub. Date: Oct. 20, 2005

(54) Compact Sewage Secondary Treatment System

(76) Inventor: Nicholas E Butts, Madoc (CA)

Correspondence Address: SHAPIRO COHEN, P.O. BOX 3440, STATION D, OTTAWA, ON, K1P6P1, CA

(21) Appl. No.: 10/362,287

(22) PCT Filed: Aug. 28, 2001
(86) PCT No.: PCT/CA01/01224

§ 371 Date: Sep. 16, 2004

(30) Foreign Application Priority Data
Aug. 29, 2000 (GB) 0021213.4

(51) Int. Cl. C02F 3/00

(52) U.S. Cl. 210/615

(57) ABSTRACT

A treatment tank (1) for the secondary treatment of sewage, for providing the processes of aeration, nitrification and denitrification, in a single structure, for which a single, small horsepower, effluent pump (26) is the only moving part. In the treatment tank (1), the sewage is subjected to two separate biological treatments, in two separate chambers under different conditions. One biological treatment is carried out under anoxic conditions in a pipe coil (3). Anoxic conditions are ensured by keeping the pipe coil (3) full at all times; the pipe coil axis is vertical, and the pump forces the fluid flow upwardly through the coil. The second biological treatment is carried out under aerobic conditions in a trickle down filter (8). In a preferred embodiment, a welded pipe coil (3) used both to provide the anoxic conditions and to provide a tank containing the trickle down filter (8). The secondary treatment tank is generally used as part of a raw sewage treatment system, which will include a recycle loop which ensures that even when there is no raw sewage entering the system there is always a flow of liquid through the treatment tank.

This invention relates to an apparatus for the secondary treatment of moderate flows of sewage effluent. It is suitable for the treatment of a sewage effluent flow derived from communities of thirty to one thousand homes. It is thus more particularly concerned with an apparatus useable in a communal sewage treatment system to treat sewage.

In a communal sewage treatment system, the sewage from a number of dwellings or establishments, for example a small town or village, is treated in order to convert the raw sewage into a water effluent that can be safely disposed of into ground water or into a larger body of water such as a stream or lake. Communal sewage treatment systems are used in locations where it is not economically feasible to provide a conventional municipal sewage processing system. In comparison to the installation of individual septic tank and tile bed systems, a communal system is more economical in land usage, and also permits a higher building density, particularly in locations where wells are required because there is no municipal water supply system. The apparatus of this invention will be located to follow a conventional primary sewage treatment system, such as a septic tank, in which insoluble solids, oils and grease are separated from the raw sewage. The apparatus of this invention generally will be used as part of a sewage treatment system which will include tankage used to equalize the effluent flow into the treatment system, tankage used to settle out suspended solids after flowing through the treatment apparatus, and at least one pump unit.

The treatment of secondary sewage generally requires the use of two process, which are generally applied in sequence to the sewage flow. Both processes rely on the presence of suitable bacteria.

The principle process in secondary sewage treatment is the aeration of the secondary sewage in the presence of certain bacteria. This process results in nitrification of the effluent. There are several known communal sewage treatment systems that oxygenate the secondary sewage by bubbling air into it. This is an inefficient method of oxygenation. With the exception of so-called trickle filters, the only practicable secondary sewage treatment apparatus that is reasonably compact is a rotating biological contactor (RBC). An RBC consists essentially of horizontal tank and a series of discs carried on a horizontal shaft which are partially immersed in the sewage in the partially filled tank. The shaft is rotated slowly, thus promoting sewage aeration. RBC's have two disadvantages. First, the apparatus is both complex, expensive to install and expensive to operate, since it includes many parts which require constant attention and maintenance. It thus requires a significant level of skilled supervision. Second, the system is relatively inefficient since its ability to aerate the sewage is directly linked to the combined surface area of the series of discs; there are practical limits on just how large these can be and on how large the RBC unit as a whole can be.

The other process is denitrification, or the reduction of total nitrogen, referred to as Total Kjeldahl Nitrogen. This is accomplished in an anoxic environment, so that bacteria, along with a supplied food source, will reduce the nitrites and nitrates present in the sewage, releasing free nitrogen gas. In the known treatment systems, denitrification is carried out by turning off the air supply, and stirring the liquid to encourage mixing. This is usually done in the same chamber as the oxygenation, with the result that the specific bacteria of the denitrification process, which are different from the oxygenation bacteria, are not allowed to concentrate.

This invention seeks to provide a secondary sewage treatment apparatus which can be compact, and which can provide the conditions for oxygenation and denitrification separately and more or less independently of each other. The apparatus can also be configured to require only one pump to move the sewage flow through it; no other moving parts are required, this minimizing supervision and maintenance requirements. In the secondary sewage treatment apparatus of this invention, the sewage is subjected to two separate biological treatments in separate parts of the same apparatus, where the specific bacteria of each process are allowed to colonize and congregate, under separate anoxic and aerobic conditions. Aerobic conditions are obtained by the use of a trickle down filter, and anoxic conditions are obtained by pumping the sewage upwardly through a pipe coil, the axis of which is substantially vertical; during operation the coil is always full, thus excluding the presence of air. The apparatus of this invention simplifies the sewage treatment process, and does not require sophisticated control equipment. In a preferred embodiment, a welded pipe coil is used as the outer cylindrical wall of the trickle down filter unit. In practice, the treatment unit of this invention is used as part of a communal sewage treatment system, which will also include suitable tankage, pipe systems and pumps.

Thus in a first embodiment this invention seeks to provide a secondary sewage treatment apparatus comprising in combination in sequence:
(a) a sewage inflow means;
(b) a circulating pump means;
(c) a coil of pipe having an inlet and an outlet, the outlet being disposed vertically higher than the inlet;
(d) a treatment tank containing a trickle down filter;
(e) a collection means to receive the flow of sewage from the trickle down filter; and
(f) an effluent outflow means; wherein:
(i) the circulating pump means provides a flow of sewage from the sewage inflow means to the pipe coil inlet at a pressure sufficient to provide a flow of sewage at the pipe coil outlet;
(ii) the pipe coil outlet is constructed and arranged to pass sewage to the trickle flow filter;
(iii) the collection means is constructed and arranged to receive a flow of treated sewage from the trickle down filter; and
(iv) the outflow means is constructed and arranged to receive the flow of treated sewage collected by the collection means.

Preferably the pipe coil is substantially cylindrical with its axis vertical More preferably, the pipe coil is substantially cylindrical with its axis vertical, and the pipe coil is welded together to provide a cylindrical wall for the treatment tank. Alternatively, the treatment tank is substantially cylindrical with its axis vertical, and the pipe coil is nested inside the treatment tank. Alternatively, the treatment tank is substantially cylindrical with its axis vertical, and the pipe coil is wound around the outside of the treatment tank.

Preferably, the sewage outflow means includes means to recirculate at least a proportion of the flow of treated sewage received from the collection means to the sewage inflow means.

Preferably, the sewage inflow means includes a mixing tank where inflowing sewage is mixed with re-circulated treated sewage from the outflow means.

Preferably, the effluent outflow means also includes a tank with a hydraulically balancing means constructed and arranged to maintain a minimum of sewage recirculating through the treatment tank, even when there is no flow of raw sewage into the treatment system.

The invention will now be described with reference to attached drawings in which:

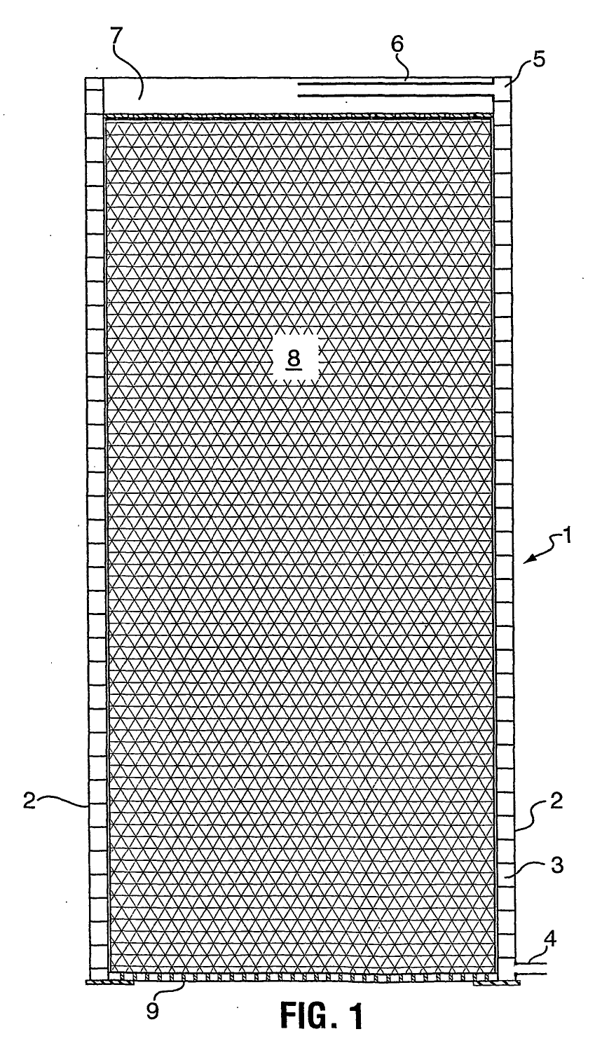

FIG. 1 shows the main features of a preferred embodiment of the treatment tank;

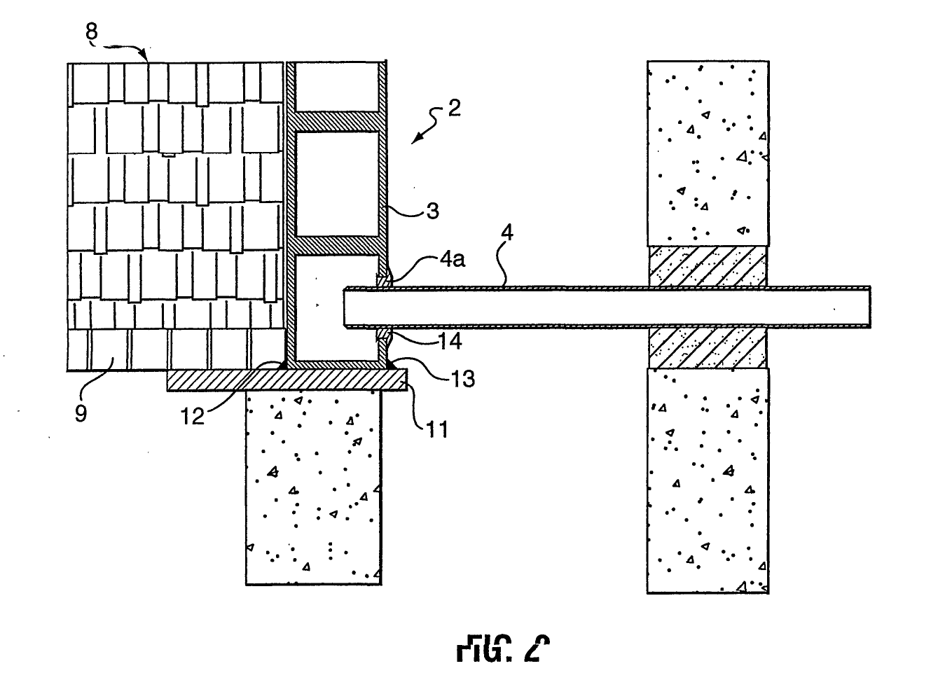

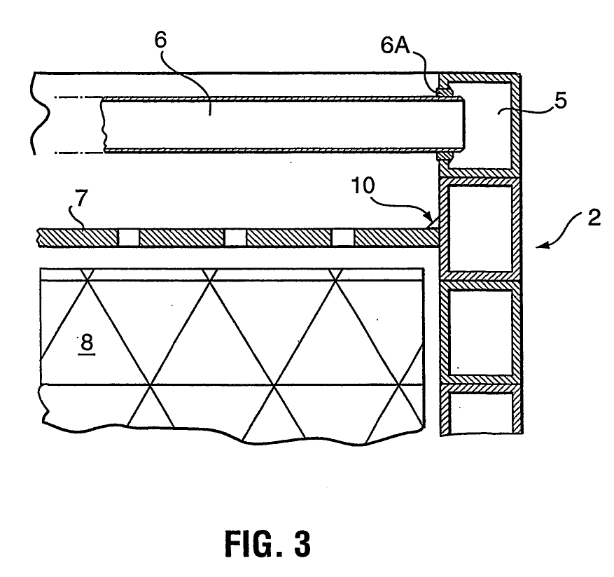

FIGS. 2, and 3 show constructional details of the treatment tank of FIG. 1;

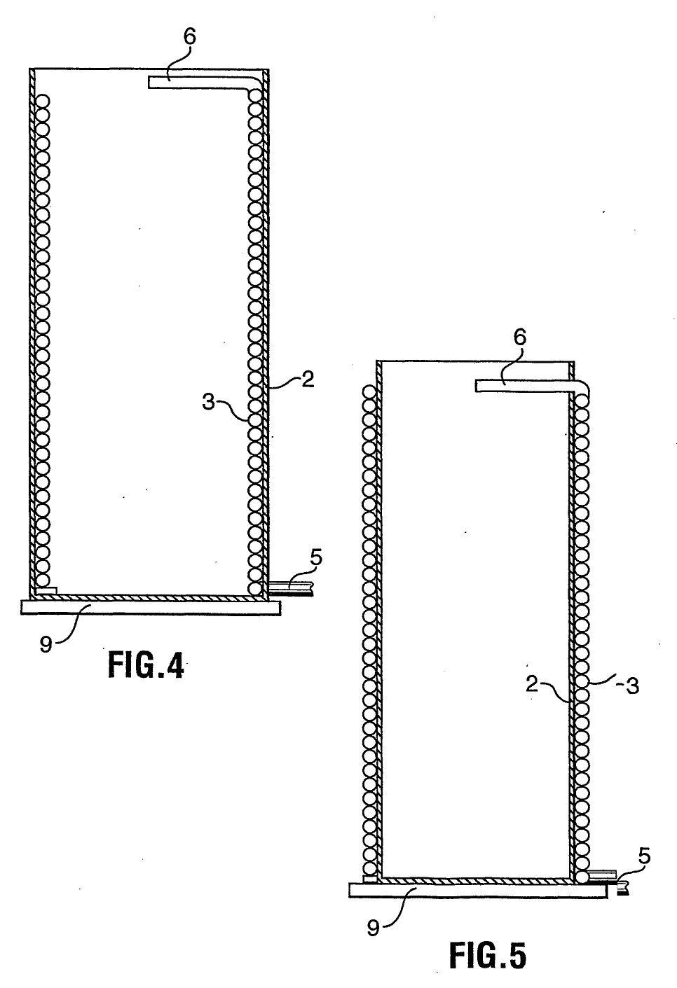

FIGS. 4 and 5 show alternative constructions for other embodiments of the pipe coil and treatment tank;

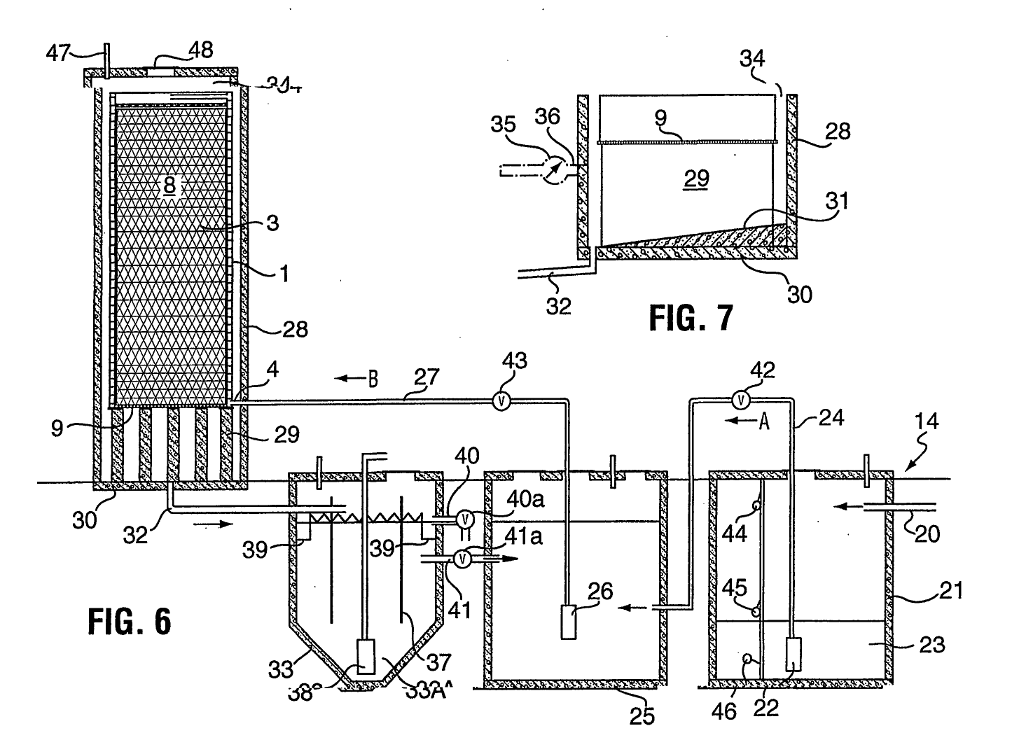

FIG. 6 shows schematically a typical complete secondary treatment system incorporating the treatment tank of FIG. 1; and

FIG. 7 shows a cross section of the tank mounting used in FIG. 6.

In this invention, the way in which the sewage is processed is determined primarily by the arrangement of the pipe coil and the treatment tank. The preferred embodiment for these components is shown in FIGS. 1, 2 3 and 4.

Referring first to FIGS. 1, 2 and 3 the treatment tank shown generally at 1 has a substantially cylindrical wall 2. The cylindrical wall 2 comprises a square section tube 3 wound and welded into a helix to provide both the cylindrical tank wall 2 and the pipe coil. The helix is fabricated as a single unit, thus saving on both the space required and apparatus cost. Welded pipe coils of this type fabricated in polyethylene are available in several pipe sizes, overall diameters and overall pipe lengths under the trade mark Weholite from KWH Pipe Ltd., of Mississauga, Ontario, Canada. If desired, the pipe coil can be fabricated from a material other than polyethylene; polythene is preferred due to its known resistance to degradation over extended periods of time in the presence of sewage.

At the bottom end of the pipe coil, the sewage inflow pipe 4 receives sewage from a circulating pump (not shown; see FIG. 6) at a pressure sufficient to overcome the pressure head of the pipe coil 2. A suitable pressure tights seal is used between the inflow pipe 4 and the pipe coil 3 as at 4A. The anoxially treated sewage leaves the top end of the pipe coil 2 at 5 through the exit pipe 6, which is also sealed to the pipe coil as at 6A. Anoxic conditions are ensured within the pipe coil 3 by the upward flow of sewage which keeps the pipe coil 3 full of liquid at all times. The sewage flow from pipe 6 is distributed by a conventional distributor 7 over the top of the trickle down filter 8. The distributor 7 is a conventional perforated plate, which also is conveniently fabricated from polyethylene and welded as at 10 to the inside surface of the pipe coil 2.

The trickle down filter 8 is supported by a grating 9, which is conveniently fabricated from fibre reinforced plastic, such as the material commonly known as fiberglass. The grating 9 is held in place by a support ring 11. If a polyethylene pipe coil is used, the support ring 12 is conveniently a polyethylene ring welded to the bottom of the polyethylene coil pipe 2 as at 12, 13. Several materials are available for the trickle filter 8; a suitable one is ACCU-PAK (trade mark), grade CF 1900 available from Brentwood Industries, of Reading, Pa., USA. As the sewage flows downwardly through the trickle filter, a suitable upward air flow is usually created through natural causes, thus ensuring aerobic conditions for the biological treatment step. If the naturally induced air flow is found to be insufficient, a blower means can be used to supplement the natural flow (see FIG. 6).

The distributor 9 and the grating 11 are both provided with a sufficient number and size of holes to allow the passage of sewage downwardly through the trickle down filter 8 and to allow a sufficient flow of air upwardly through the trickle down filter 8.

The treatment tank 1 is designed and fabricated in such a way that the distributor plate 7 and the support ring 11 act to lock the trickle filter 8 and the grating 9 in place, allowing the whole unit to be laid on its side for shipping. It can thus be seen that the treatment tank itself can be fabricated from a single material which is unaffected by raw sewage, such as polyethylene or polyvinyl chloride (PVC), contains no moving parts and needs only a small amount of space.

It is also contemplated within this invention that the pipe coil can be fabricated as a separate free standing unit, located near to the treatment tank, in an appropriate vertical position to ensure that anoxic conditions are maintained within the coil. This arrangement has the disadvantage of requiring approximately twice as much space as the unit of FIG. 1. Alternatively, the pipe coil 3 can be fabricated separately, and either nested within the tank 2, as shown schematically in FIG. 4, or wound around the outside of the tank 2, as shown schematically in FIG. 5.

FIG. 6 shows schematically a typical complete secondary sewage treatment system incorporating the treatment tank of FIG. 1. In FIG. 6 the arrows indicate directions of flow within the system, and the line 14 indicates ground level around the system.

Raw anaerobic sewage enters the system in pipe 20 from a primary treatment unit such as a conventional septic tank, which separates oil, grease, and insolubles such as grit from the raw sewage (not shown). The raw sewage enters a flow equalization tank 21. A first submersible effluent pump 22 pumps the raw sewage 23 at a constant rate through pipe 24 to a mixing tank 25. A second submersible pump 26 pumps mixed sewage 25 from the tank 25 to the treatment tank 1, which is constructed as shown in FIG. 1. The submersible pump 26 develops sufficient pressure at the inlet 4 to the treatment tank 1 to overcome the hydraulic head within the pipe coil 3. The treatment tank 1 is contained within a suitable casing 28 such as a concrete silo, partly for safety and partly for weather protection.

Inside the casing 28 the treatment tank 1 is supported by a set of benches 29 supported by the base 30 of the casing 28. A sloping floor 31 is provided within the casing 28 which serves to direct the flow of treated sewage from the grating 9 to the sewage outflow pipe 32. The pipe 32 delivers the treated sewage flow, which will also usually contain sloughed off bacterial debris from the trickle down filter 8, to a settling tank 33. The free space 34 around the treatment tank 1 normally ensures a sufficient flow of air through the trickle down filter 8. If it is found that the natural air flow is insufficient, additional air flow can be provided by a suitable blower 35 which feeds air into the casing 28 through the pipe 36 (both shown ghosted in FIG. 7) into the casing 28.

The treated sewage in pipe 32 enters a settling well 37 supported inside the settling 33. Inside the well 37 any biological debris, and any other solid matter in the treated sewage, settles to the bottom part 33A and is periodically removed by the scavenge pump 38. The solids free treated sewage has two pathways out of the settling tank 33; which is used depends upon the amount of raw sewage entering the treatment system in pipe 20.

If the pump 22 in the flow equalization tank 21 is pumping raw sewage into the mixing tank 25, then treated sewage will leave the settling tank 33 through pipe 40 for final disposal. Treated sewage will also leave the settling tank 33 through pipe 41, through which it is returned to the mixing tank 25. Alternatively, if the pump 22 is not pumping raw sewage into the mixing tank 25, then the liquid level in the settling tank 33 will fall below the weir 39, and the only flow out of the settling tank 33 is through pipe 41 to the mixing tank 25. This arrangement has two advantages. First, when the pump 22 is feeding raw sewage, the settling tank acts a flow splitting device, ensuring that only a part of the treated sewage entering in pipe 32 is discharged in pipe 40, and the remainder is returned through pipe 41 to the mixing tank. This recycle loop ensures proper treatment of the incoming raw sewage. Second, when the pump 22 is not pumping raw sewage into the flow equalization tank, all of the treated sewage in pipe 32 entering the settling tank 33 is returned through pipe 41 and then by pump 26 to the treatment tank 1, thus ensuring that the pipe coil 3 is kept full of liquid, and the trickle down filter 8 is always kept wet. This ensures that the bacterial populations in the pipe coil 3 and on the trickle down filter 8 continue to thrive at all times. If required, in order to ensure that the correct flow rates are obtained in pipes 40 and 41, suitable valves 40A and 41A are included in pipes 40 and 41 respectively.

It can thus be seen that the tank 33 together with its associated pipe connections provides a hydraulic balancing means constructed and arranged to maintain a minimum of sewage recirculating through the treatment tank, even when there is no flow of raw sewage into the treatment system.

The ratio between the flow rates in pipes 40 and 41 is determined by the settings of pumps 22 and 26, and the setting of the control valves 42 and 43. In practice, it has been found that pumps 22 and 26 and valves 42 and 43 should be coordinated so that the flow at B in pipe 27 is at least approximately twice the flow at A in pipe 24. If the flow rate ratio A:B is less than approximately 1:2 then adequate treatment of the raw sewage will not necessarily be obtained. The ratio A:B can be as high as 1:4 if desired; it practice it appears that a ratio within the range of from 1:2 to 1:3 is generally sufficient. For most applications, a ratio of 1:2 appears to be adequate.

Since the flow rate of the incoming raw sewage is rarely constant, it is convenient to provide float activated control switches 44, 45 and 46 in the equalization tank 21. Switch 44 is activates a high level alarm, indicating that the level in tank 21 is too high. There can be several reasons for this; for example if the raw sewage flow in pipe 20 is more than the system can handle, or if pump 22 has failed. Switches 45 and 46 act together: switch 45 turns on pump 22 when there is sufficient raw sewage in tank 21, and switch 46 turns off pump 22 when the liquid level in tank 21 falls below a preset minimum. Varying flow rates in pipe 20 are then accommodated by the level difference between switches 44 and 45.

In practice, it has been found convenient to install the treatment tank 1 above the surrounding ground level indicated at 14, and the other three tanks 21, 25 and 33 below ground level. All of the tanks will also normally be vented as at 47, and provided with an access inspection cover as at 48. The manner in which these units are installed needs to take into account the thermal requirements of the microbiological colonies which are essential to the operation of the treatment tank 1. These normally only work well within a temperature range of from about 15° C. to about 50° C. It may thus be necessary to provide protection against ambient temperatures outside this range. It may also be necessary to provide for heating and/or cooling of the air flow through the trickle down filter 8. It has also been found advantageous to use electric submersible self priming pumps for the units 22, 26 and 38.

1. A secondary sewage treatment apparatus comprising in combination in sequence:
(a) a sewage inflow means;
(b) a circulating pump means;
(c) a coil of pipe having an inlet and an outlet, the outlet being disposed vertically higher than the inlet;
(d) a treatment tank containing a trickle down filter;
(e) a collection means to receive the flow of sewage from the trickle down filter; and
(f) an effluent outflow means;
wherein:
(i) the circulating pump means provides a flow of sewage from the sewage inflow means to the pipe coil inlet at a pressure sufficient to provide a flow of sewage at the pipe coil outlet;
(ii) the pipe coil outlet is constructed and arranged to pass sewage to the trickle flow filter;
(iii) the collection means is constructed and arranged to receive a flow of treated sewage from the trickle down filter; and
(iv) the outflow means is constructed and arranged to receive the flow of treated sewage collected by the collection means.

2. A secondary sewage treatment apparatus according to claim 1 wherein the pipe coil is substantially cylindrical with its axis vertical.

3. A secondary sewage treatment apparatus according to claims 1 wherein the pipe coil is substantially cylindrical with its axis vertical, and the pipe coil is welded together to provide a cylindrical wall for the treatment tank.

4. A secondary sewage treatment apparatus according to claim 1 or 2 wherein the treatment tank is substantially cylindrical with its axis vertical, and the pipe coil is nested inside the treatment tank.

5. A secondary sewage treatment apparatus according to claim 1 wherein the treatment tank is substantially cylindrical with its axis vertical, and the pipe coil is nested inside the treatment tank.

6. A secondary sewage treatment apparatus according to claim 1 wherein the treatment tank is substantially cylindrical with its axis vertical, and the pipe coil is wound around the outside of the treatment tank.

7. A secondary sewage treatment apparatus according to claim 2 wherein the treatment tank is substantially cylindrical with its axis vertical, and the pipe coil is wound around the outside of the treatment tank.

8. A secondary sewage treatment apparatus according to claim 1 wherein the sewage outflow means includes means to recirculate at least a proportion of the flow of treated sewage received from the collection means to the sewage inflow means.

9. A secondary sewage treatment apparatus according to claim 3 wherein the sewage outflow means includes means to recirculate at least a proportion of the flow of treated sewage received from the collection means to the sewage inflow means.

10. A secondary sewage treatment apparatus according to claim 1 wherein the sewage outflow means includes means to recirculate at least a proportion of the flow of treated sewage received from the collection means to the sewage inflow means.

11. A secondary sewage treatment apparatus according to claim 3 wherein the sewage outflow means includes means to recirculate at least a proportion of the flow of treated sewage received from the collection means to the sewage inflow means.

12. A secondary sewage treatment apparatus according to claim 10 wherein the sewage recirculation means is constructed and arranged to recirculate at least one half of the flow of treated sewage.

13. A secondary sewage treatment apparatus according to claim 10 wherein the sewage recirculation means is constructed and arranged to recirculate at least one half of the flow of treated sewage.

14. A secondary sewage treatment apparatus according to claim 10 wherein the sewage recirculation means is constructed and arranged to recirculate about one half of the flow of treated sewage.

15. A secondary sewage treatment apparatus according to claim 10 wherein the sewage recirculation means is constructed and arranged to recirculate about one half of the flow of treated sewage.

16. A secondary sewage treatment apparatus according to claim 12 wherein the sewage inflow means includes a mixing tank where inflowing sewage is mixed with re-circulated treated sewage from the outflow means.

17. A secondary sewage treatment apparatus according to claim 13 wherein the sewage inflow means includes a mixing tank where inflowing sewage is mixed with re-circulated treated sewage from the outflow means.

18. A secondary sewage treatment apparatus according to claim 1 wherein the effluent outflow means further includes a tank with a hydraulic balancing means constructed and arranged to maintain a minimum of sewage recirculating through the treatment tank, even when there is no flow of raw sewage into the treatment system.

19. A secondary sewage treatment apparatus according to claim 3 wherein the effluent outflow means also includes a tank with a hydraulic balancing means constructed and arranged to maintain a minimum of sewage recirculating through the treatment tank, even when there is no flow of raw sewage into the treatment system.
